(19) United States
(12) Patent Application Publication
(10) Pub. No.: US 2007/0011463 A1
(43) Pub. Date: Jan. 11, 2007

(54) METHOD, SYSTEM, AND COMPUTER PROGRAM PRODUCT FOR PROVIDING AUTHENTICATION AND ENTITLEMENT SERVICES

(75) Inventor: Steven M. Garfinkle, Cold Spring, NY (US)

Correspondence Address: CANTOR COLBURN LLP - IBM FISHKILL, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/160,720

(22) Filed: Jul. 6, 2005

(51) Int. Cl. H04K 1/00

(52) U.S. Cl. 713/186

(57) ABSTRACT

A method, system, and computer program product for providing authentication and entitlement services is provided. The method includes creating a profile record and associating an access element with the record, the access element coupled to a biometric scan device. The method also includes receiving a first instance of at least two biometric scans. The method further includes receiving a first sequence for the first instance, which specifies an order of the at least two biometric scans. The method also includes receiving an access request via the access element and the biometric scan device, which includes a second instance of at least two biometric scans, and which are received in a second sequence. The method further includes comparing the first and second instances and the first and second sequences, and granting the access request only if the first and second instances match and only if the first and second sequences match.

### BACKGROUND OF THE INVENTION

The present disclosure relates generally to information and systems security and, in particular, to a method, system, and computer program product for providing authentication and entitlement services.

Security systems are widely used in ensuring the integrity of electronic information and applications, as well as physical locations. Typically, these systems include techniques for protecting unauthorized access to locations (e.g., security alarms and locking mechanisms) and information (e.g., data encryption, user identification and password combinations). Data encryption refers to a process that translates data into an unintelligible form and which requires a deciphering component or key in order to produce the original data or document. A password system relies on a unique, secret word known only to the individual to which it is assigned (and perhaps a systems administrator, if applicable).

It is quite common for an individual to own several different passwords and utilize various related security mechanisms (e.g., encryption services). For example, an individual may establish a different user ID and password for access to various websites. In addition, an individual may possess multiple encryption keys commensurate with a number of correspondents to which secure communications are delivered and are received. In most instances, it can be very burdensome to remember these passwords and related information. Accordingly, many individuals store this information in a computer or other communications device for later retrieval.

Clearly, these security systems afford some protection, as long as an individual maintains continuous control over the device storing this security information. However, if the device is lost or stolen, this information can be compromised. In this case, the individual would need to recall all of the security information stored and modify it (e.g., change passwords).

What is needed, therefore, is a security system that prevents unauthorized access to electronic information and applications, as well as to physical locations.

### BRIEF SUMMARY OF THE INVENTION

Embodiments of the invention include a method for providing authentication and entitlement services. The method includes creating a profile record and associating an access element with the record, the access element coupled to a biometric scan device. The method also includes receiving a first instance of at least two biometric scans. The method further includes receiving a first sequence for the first instance, which specifies an order of the at least two biometric scans. The method also includes receiving an access request via the access element and the biometric scan device, which includes a second instance of at least two biometric scans, and which are received in a second sequence. The method further includes comparing the first and second instances and the first and second sequences, and granting the access request only if the first and second instances match and only if the first and second sequences match.

A system for providing authentication and entitlement services includes a host system in communication with an access element via a network, the access element communicatively coupled to at least one biometric scan device. The system also includes a security scan application executing on the host system. The security scan application performs a method. The method includes creating a profile record and associating an access element with the record, the access element coupled to a biometric scan device. The method also includes receiving a first instance of at least two biometric scans. The method further includes receiving a first sequence for the first instance, which specifies an order of the at least two biometric scans. The method also includes receiving an access request via the access element and the biometric scan device, which includes a second instance of at least two biometric scans, and which are received in a second sequence. The method further includes comparing the first and second instances and the first and second sequences, and granting the access request only if the first and second instances match and only if the first and second sequences match.

In accordance with another embodiment of the invention, a computer program product for providing authentication and entitlement services includes instructions for executing a method. The method includes creating a profile record and associating an access element with the record, the access element coupled to a biometric scan device. The method also includes receiving a first instance of at least two biometric scans. The method further includes receiving a first sequence for the first instance, which specifies an order of the at least two biometric scans. The method also includes receiving an access request via the access element and the biometric scan device, which includes a second instance of at least two biometric scans, and which are received in a second sequence. The method further includes comparing the first and second instances and the first and second sequences, and granting the access request only if the first and second instances match and only if the first and second sequences match.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of a system upon which authentication and entitlement services may be implemented in exemplary embodiments;

FIG. 2 is a flow diagram describing a process for establishing a profile for use in implementing the authentication and entitlement services in exemplary embodiments;

FIG. 3 is a sample user interface screen of the authentication and entitlement system in accordance with exemplary embodiments; and

FIG. 4 is a flow diagram describing a process for implementing the authentication and entitlement services in exemplary embodiments.

The detailed description explains the preferred embodiments of the invention, together with advantages and features, by way of example with reference to the drawings.

### DETAILED DESCRIPTION OF THE INVENTION

In accordance with exemplary embodiments, a method, system, and computer program product for providing authentication and entitlement services is disclosed. The authentication and entitlement services provide a means for preventing unauthorized access to electronic information and applications, as well as to physical locations. One or more scanner devices installed on an access element or location enables an individual to supply biometric data that is coupled with security information to control and secure various systems and information.

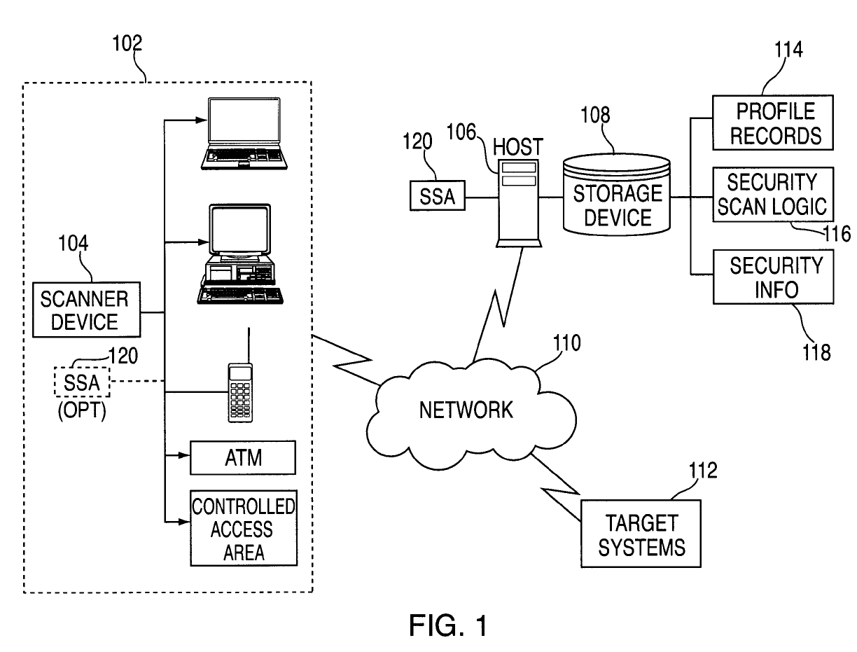

Turning now to FIG. 1, a system upon which the authentication and entitlement services may be implemented in accordance with exemplary embodiments will now be described. The system depicted in FIG. 1 includes one or more access elements 102 through which individuals at one or more geographic locations may seek authorization and access to electronic information, applications, or locations. These access elements 102 communicate with a host system 106 via one or more networks, such as network 110. In accordance with exemplary embodiments, the host system 106 executes computer instructions for implementing the authorization and entitlement services. Each access element 102 may include a processor for carrying out the security activities described herein. Access elements 102 may include a laptop, personal computer, personal digital assistant, host attached terminal, automated teller machine (ATM), or any device through which access to information or applications is desired. This information and applications may reside directly on one more of the access elements, if applicable, or may be remotely located from the access elements (e.g., target systems 112 and/or security information 118). Additionally, access elements 102 may comprise one or more devices placed at a location to which individuals seek access (e.g., entranceway to a restricted building) and which control access to the location. These locations are referred to herein as controlled access areas.

If the access elements 102 are personal computers or similar type of processing devices, the processing described herein may be shared by the access element 102 and the host system 106 (e.g., by providing an applet to the access element 102). The processing devices, in turn, may execute applications such as email software, web browser programs, and encryption tools.

The authorization and entitlement services may be well suited for a variety of applications (e.g., in a military or government installation where buildings, hallways, and rooms require restricted access or where classified documents are stored; in a medical facility where access to patient records is restricted; financial institutions where physical locations such as vaults must be protected; in a corporate facility where trade secrets are heavily guarded; business environments where information databases store confidential or proprietary information; and personal applications such as passwords for private accounts or online activities, etc.).

As shown in the system of FIG. 1, each of the access elements 102 includes a scanner device 104, which may be installed directly on, or is otherwise coupled to, the access devices 102. Scanner device 104 receives biometric data from an individual, such as retina scan data or finger print scan data for authenticating the individual. Any suitable scanner device 104 may be employed (e.g., optical scanner, capacitance scanner, etc.). Additionally, multiple scanner devices 104 utilizing various technologies may be employed for each access element 102 such as, but not limited to, facial recognition, hand geometry, and voice recognition.

Target systems 112 are also provided in the system of FIG. 1. Target systems 112 refer to any network-based device, application, information database, etc. that is remotely located from access elements 102 and to which access is desired. For example, target systems 112 may include a third-party website, a confidential document, database, program, or account that is stored on, e.g., a network server. Individuals may communicate with target devices 112 via an access device 102 over network 110.

The network 110 may be any type of known network including, but not limited to, a wide area network (WAN), a local area network (LAN), a global network (e.g. Internet), a virtual private network (VPN), and an intranet. The network 110 may be implemented using a wireless network or any kind of physical network implementation known in the art. An access element 102 may be coupled to the host system 106 through multiple networks (e.g., intranet and Internet) so that not all access elements 102 are coupled to the host system 106 through the same network. One or more of the access elements 102 and the host system 106 may be connected to the network 110 in a wireless fashion. In one embodiment, the network 110 is an intranet and one or more access elements 102 execute a user interface application (e.g. a web browser) to contact the host system 106 through the network 110. In another exemplary embodiment, the access element 102 is connected directly (i.e., not through the network 110) to the host system 106 and the host system 106 is connected directly to, or contains, the storage device 108.

The host system 106 depicted in FIG. 1 may be implemented using one or more servers operating in response to a computer program stored in a storage medium accessible by the host system 106. The host system 106 may operate as a network server (e.g., a web server) to communicate with the access elements 102. The host system 106 handles sending and receiving information to and from the access elements 102 and can perform associated tasks.

The host system 106 may also operate as an application server. The host system 106 executes one or more computer programs for providing authentication and entitlement services. These one or more applications are referred to as a security scan application 120. Processing may be shared by the access elements 102 and the host system 106 by providing an application (e.g., java applet) to the access elements 102. Alternatively, the access elements 102 can include stand-alone software for performing a portion or all of the processing described herein. As previously described, it is understood that separate servers may be utilized to implement the network server functions and the application server functions.

The storage device 108 houses data relating to security systems, user profiles, and related information, and may be implemented using a variety of devices for storing electronic information. It is understood that the storage device 108 may be implemented using memory contained in the host system 106 or it may be a separate physical device. The storage device 108 is logically addressable as a consolidated data source across a distributed environment that includes a network 110. Information stored in the storage device 108 may be retrieved and manipulated via the host system 106 and/or via the access elements 102.

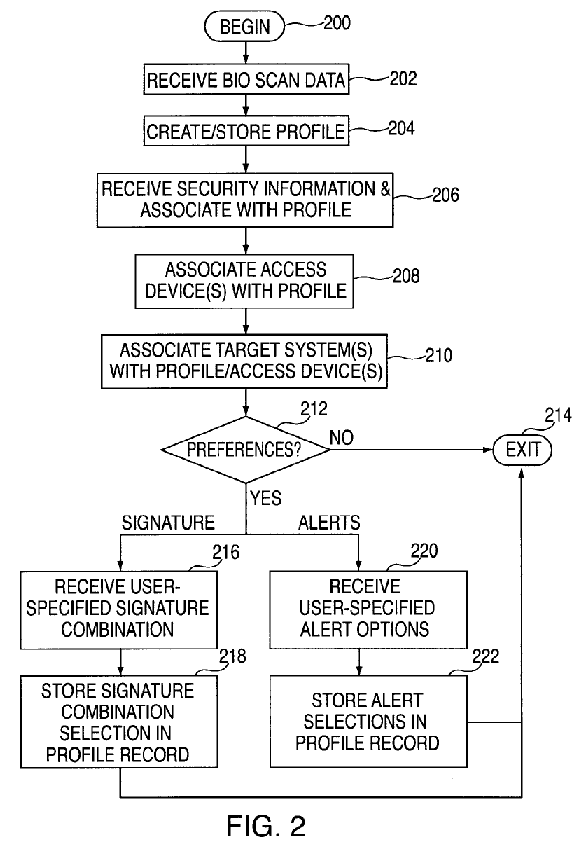

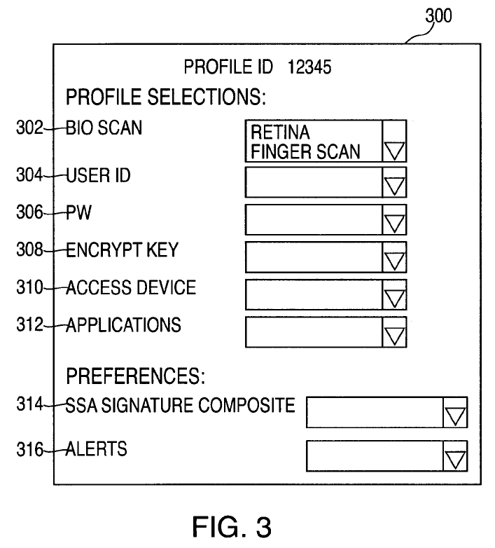

Information stored in storage device 108 may include profile records 114, security scan logic 116, and security information 118. The profile records 114 contain information for each registrant of the authentication and entitlement services. A registrant may be an entity that is responsible for multiple individuals that require access to information or systems, whereby the registrant performs some of the registration activities described in FIG. 2 on behalf of the individuals. Alternatively, a registrant may be an individual that seeks the security services offered by the authentication and entitlement system for personal use. A individual or entity registering for the authentication and entitlement services are also referred to herein as subscribers. Information included in profile records 114 may be provided via a user interface of the security scan application 120, a sample of which is shown and described in FIG. 3. Security scan logic 116 provides analysis capabilities in determining whether biometric data provided in a request for access to information matches the biometric data in the profile records, as well as biometric data sequences (referred to as signature composites or combinations). These are described further herein. Security information 118 refers to the information for which protection is sought (e.g., passwords, encryption keys, account information, etc.). In exemplary embodiments, the host system 106 operates as a database server and coordinates access to application data including data stored on the storage device 108.

In accordance with exemplary embodiments, the authentication and entitlement services are initiated by a user of access element 102 through a registration process. The user registers for these services with host system 106 via, e.g., a computer over network 110 (where the computer may or may not be an access element 102), and may also establish user preferences relating to the nature of, and conditions under which authentication and entitlement services are employed. In alternative exemplary embodiments, some of these authentication and entitlement services may be implemented by a client-side application executing on the access element 102.

Turning now to FIG. 2, a flow diagram describing a process for establishing a profile for use in implementing the authentication and entitlement services in accordance with exemplary embodiments will now be described. The process begins at step 200 whereby a user (also referred to as security scan subject or subscriber) of access element 102 enters biometric data into the access element via the scanner device 104. The biometric data may be, e.g., a fingerprint or retina scan, hand geometry, voice recognition, etc., depending upon the type of scanner device(s) 104 installed on the access element 102. The security scan application 120 receives the biometric scan data at step 202. If the host system 106 is implementing the authentication and entitlement services, the biometric data is transmitted from the access element 102 over network 110 to the host system 106.

At step 204, the security scan application 120 creates a profile record for the new biometric scan. Information included in the profile record may be provided via a user interface screen, a sample of which is shown in FIG. 3. The profile record may be assigned a unique identifier or profile ID by the security scan application 120. At step 206, the security scan application 120 associates security information with the profile record, such as passwords, encryption key data, financial data, etc. This security information may be provided by the security scan subject via fields 304-308 of user interface screen 300. At step 208, the security scan application 120 associates one or more access elements 102 with the profile record. This information may be provided via field 310 of user interface screen 300. This option may be useful when a user has multiple access elements 102 so that only a single profile record is needed for all of the user's access elements 102. Alternatively, the access elements 102 may be automatically associated with the profile record as a default mechanism of the security scan application 120 (e.g., the access device in which the user provides the biometric data is automatically associated with the profile record).

At step 210, the security scan application 120 associates one or more target systems 112 with the profile record (e.g., website addresses, online bank accounts, secure databases, etc.) via field 312. The security scan application 120 enables a user to select preferences for applying authentication and entitlement services. For example, the user may wish to customize the authentication procedures used when attempting to access selected information, applications, or locations. The security scan application 120 enables a user to provide multiple instances of biometric data and identify a sequence for the data to be used in the authentication and entitlement process. For example, suppose an access device 102 comprises a single finger print scan device 104. The user may provide biometric data for an index finger, ring finger, and thumb which is received at, and stored by, the security scan application 120. The user may then identify a unique sequence of scans (e.g., scan ring finger first, followed by thumb, and then index finger in sequence) in order to authenticate the user. This may be provided via field 314 of user interface screen 300. If multiple scanner devices are employed, the user may identify a sequence of scans from these devices to be used in the authentication process. Any combination of scans may be identified and used. This combination or sequence is referred to herein as a signature combination or signature composite. During authentication, the security scan logic 116 would not only evaluate the scans for matching prints, but would also evaluate the scan sequencing as part of the authentication process. Additional preferences that may be customized include, e.g., selecting a maximum number of login or access attempts before denying access to the user.

Additional preferences selectable by a user include specifying a procedure for alerting the user of an access violation (e.g., a failed access attempt, an access attempt occurring off-schedule, etc.). A user may identify specific notification or alert procedures to be followed, such as send an email or voicemail to an access element 102 or other communications device (e.g., telephone, pager, etc.). The alert procedure may also include shutting or locking down an access element 102 under specified conditions. The alert procedure may include notifying an authority such as police, security department, etc., if desired. These alert preferences may be provided via field 316 of user interface 300.

In accordance with exemplary embodiments, preferences may also be supplied for enabling a user to determine whether the entitlement process will invoke automated security functions. For example, if the access device 102 is a personal computer that includes an encryption/decryption tool, the user may configure the security scan application 120 to provide automatic encryption for outgoing emails. In other words, upon authentication the user accesses an email program and composes a message to an intended recipient. Without further action on the part of the user, the security scan application 120 may automatically encrypt the message prior to its transmission. This option may be facilitated during registration through the encryption key field 308 of user interface 300 and the user's contact list from the email program. In another example, the user has an account with an online entity and, upon authentication, types in a website address via a web browser residing on the access element 102. The security scan application 120 automatically locates a corresponding user identification and password in the profile record (which was supplied earlier in fields 304 and 306) for logging into the website without requiring any action on the part of the user.

At step 212, it is determined whether the user has selected any of these preferences. If not, the process ends at step 214 and the information is stored in storage device 108 (or alternatively, access element 102 or a combination of both). Otherwise, if the preferences selected relate to a signature scan combination or composite, the security scan application 120 receives the selections at step 216 and stores them with the profile record at step 218. Likewise, if the preferences selected relate to alerts, the security scan application 120 receives the selections at step 220 and stores them with the profile record at step 222. In either case, the process then ends at step 214.

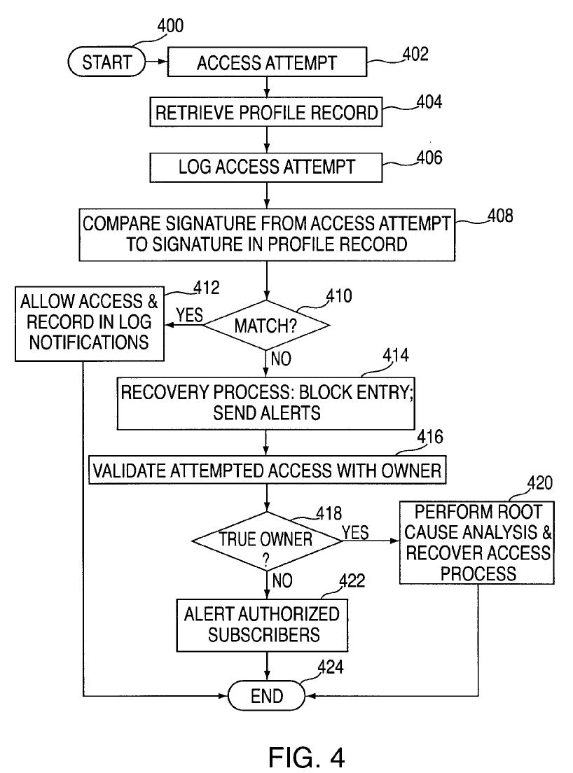

Once these settings are in place, the authentication and entitlement services may be applied as will now be described in the flow diagram of FIG. 4. The process begins at step 400 whereby a user attempts to access an access element 102 via one or more scanner devices 104 at step 402. The access attempt may include providing a user name or other identification. The security scan application 120 retrieves a profile record based upon the information obtained via the access attempt (e.g., a URL, a user ID, biometric data, etc.) at step 404 and logs this attempt in a log file stored, e.g., in storage device 108 at step 406.

At step 408, the security scan logic 116 compares the biometric data provided in the access attempt to the biometric data on file. This step may also include comparing the signature composite provided in the scan, if applicable, to the signature composite on file. At step 410, it is determined whether the two scans are a match. If so, the user is authenticated and provided access (i.e., entitled) at step 412. This authentication may be recorded in the log file. Notifications may be delivered in accordance with any alert preferences provided, if applicable.

If the two scans do not match at step 410, a recovery process is initiated by the security scan application 120 at step 414. This may include sending alerts to individuals or systems that are specified in the alert preferences. This may also include sending a signal to a security system that operates to shut down a physical location or target device. The security scan application 120 may be configured to attempt to validate the user by contacting a supervisory agent or owner (e.g., manager of the user, security department, etc.) and providing the agent or owner with specific information concerning the access attempt at step 416. The agent or owner may override the access denial under specified conditions. If the agent or owner validates the user at step 418, a root cause analysis of the problem that resulted in the initial denial of access may be performed at step 420 in order to prevent future occurrences. The process then ends at step 424. If the user is not validated by the owner or agent at step 418, a notification may be sent to relevant parties or subscribers (e.g., individuals responsible for maintaining the access elements) at step 422 and the process ends at step 424.

The authentication and entitlement services provide a means for preventing unauthorized access to electronic information and applications. One or more scanner devices installed on an access element enables an individual to supply biometric data that is coupled with security information to control and secure systems and information.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for providing authentication and entitlement services, comprising:
creating a profile record and associating an access element with the profile record, the access element communicatively coupled to at least one biometric scan device;
receiving a first instance of at least two biometric scans from an individual and storing the first instance in the profile record, wherein a first of the at least two biometric scans comprises a subject that is different than a second of the at least two biometric scans;
receiving a first sequence for the first instance and storing the first sequence in the profile record, the first sequence specifying an order of the at least two biometric scans;
receiving an access request via the access element and the at least one biometric scan device, the access request including a second instance of at least two biometric scans, the at least two biometric scans of the second instance received in a second sequence;
comparing the first and second instances and the first and second sequences; and
granting the access request only if the first instance matches the second instance and only if the first sequence matches the second sequence.

2. The method of claim 1, further comprising:
associating security information with the profile record, the security information including at least one of:
a password;
encryption key data; and
financial account data;
wherein the granting the access request includes at least one of:
providing access to the target system includes providing access to the security information; and
retrieving the security information and providing automatic access via the security information to at least one protected: file, document, application, database, and account.

3. The method of claim 1, wherein the granting the access request includes providing access to a physical location.

4. The method of claim 1, further comprising:
receiving user-specified alert settings and storing the user-specified alert settings in the profile record, the user-specified alert settings including:
conditions for generating an alert, the conditions including at least one of:
a failed access attempt;
an access attempt occurring off-schedule; and
a defined number of failed access attempts reached;
a manner of conveying the alert, comprising at least one of:
email;
telephone call;
an alarm trigger; and
a pager alert; and
a destination for conveying the alert, comprising at least one of:
an individual that created the alert settings;
a security department;
a system administrator; and
police department.

5. The method of claim 1, wherein the access element comprises at least one of:
a personal computer;
a host-attached workstation;
a personal digital assistant;
a telephone;
an automated teller machine; and
a controlled access area.

6. The method of claim 1, wherein the biometric scans include at least one of:
finger print scan;
retina scan;
hand geometry; and
voice recognition.

7. The method of claim 1, wherein the biometric scan device comprises at least one of:
an optical scanner; and
a capacitance scanner.

8. A system for providing authentication and entitlement services, comprises:
a host system in communication with an access element via a network, the access element communicatively coupled to at least one biometric scan device; and
a security scan application executing on the host system, the security scan application performing:
creating a profile record and associating the access element with the profile record;
receiving a first instance of at least two biometric scans from an individual and storing the first instance in the profile record, wherein a first of the at least two biometric scans comprises a subject that is different than a second of the at least two biometric scans;
receiving a first sequence for the first instance and storing the first sequence in the profile record, the first sequence specifying an order of the at least two biometric scans;
receiving an access request via the access element and the at least one biometric scan device, the access request including a second instance of at least two biometric scans, the at least two biometric scans of the second instance received in a second sequence;
comparing the first and second instances and the first and second sequences; and
granting the access request only if the first instance matches the second instance and only if the first sequence matches the second sequence.

9. The system of claim 8, wherein the security scan application further performs associating security information with the profile record, the security information including at least one of:
a password;
encryption key data; and
financial account data;
wherein the granting the access request includes at least one of:
providing access to the target system includes providing access to the security information; and
retrieving the security information and providing automatic access via the security information to at least one protected: file, document, application, database, and account.

10. The system of claim 8, wherein the granting the access request includes providing access to a physical location.

11. The system of claim 8, wherein the security scan application further performs:
receiving user-specified alert settings and storing the user-specified alert settings in the profile record, the user-specified alert settings including:
conditions for generating an alert, the conditions including at least one of:
a failed access attempt;
an access attempt occurring off-schedule; and
a defined number of failed access attempts reached;
a manner of conveying the alert, comprising at least one of:
email;
telephone call;
an alarm trigger; and
a pager alert; and
a destination for conveying the alert, comprising at least one of:
an individual that created the alert settings;
a security department;
a system administrator; and
police department.

12. The system of claim 8, wherein the access element comprises at least one of:
a personal computer;
a host-attached workstation;
a personal digital assistant;
a telephone;
an automated teller machine; and
a controlled access area.

13. The system of claim 8, wherein the biometric scans include at least one of:
finger print scan;
retina scan;
hand geometry; and
voice recognition.

14. The system of claim 8, wherein the biometric scan device comprises at least one of:
an optical scanner; and
a capacitance scanner.

15. A computer program product for providing authentication and entitlement services, the computer program product including instructions for executing a method, the method comprising:
creating a profile record and associating an access element with the profile record, the access element communicatively coupled to at least one biometric scan device;
receiving a first instance of at least two biometric scans from an individual and storing the first instance in the profile record, wherein a first of the at least two biometric scans comprises a subject that is different than a second of the at least two biometric scans;
receiving a first sequence for the first instance and storing the first sequence in the profile record, the first sequence specifying an order of the at least two biometric scans;
receiving an access request via the access element and the at least one biometric scan device, the access request including a second instance of at least two biometric scans, the at least two biometric scans of the second instance received in a second sequence;
comparing the first and second instances and the first and second sequences; and
granting the access request only if the first instance matches the second instance and only if the first sequence matches the second sequence.

16. The computer program product of claim 15, wherein the method further comprises:
associating security information with the profile record, the security information including at least one of:
a password;
encryption key data; and
financial account data;
wherein the granting the access request includes at least one of: providing access to the target system includes providing access to the security information; and
retrieving the security information and providing automatic access via the security information to at least one protected: file, document, application, database, and account.

17. The computer program product of claim 15, wherein the granting the access request includes providing access to a physical location.

18. The computer program product of claim 15, wherein the method further comprises:
receiving user-specified alert settings and storing the user-specified alert settings in the profile record, the user-specified alert settings including:
conditions for generating an alert, the conditions including at least one of:
a failed access attempt;
an access attempt occurring off-schedule; and
a defined number of failed access attempts reached;
a manner of conveying the alert, comprising at least one of:
email;
telephone call;
an alarm trigger; and
a pager alert; and
a destination for conveying the alert, comprising at least one of:
an individual that created the alert settings;
a security department;
a system administrator; and
police department.

19. The computer program product of claim 15, wherein the access element comprises at least one of:
a personal computer;
a host-attached workstation;
a personal digital assistant;
a telephone;
an automated teller machine; and
a controlled access area.

20. The computer program product of claim 1 5, wherein the biometric scans include at least one of:
finger print scan;
retina scan;
hand geometry; and
voice recognition.
